(19) United States
(12) Patent Application Publication
(10) Pub. No.: US 2026/0097947 A1
(43) Pub. Date: Apr. 9, 2026

(54) FORKLIFT SAFETY CONTROL SYSTEM AND FORKLIFT

(71) Applicants: TE Connectivity Solutions GmbH, Schaffhausen (CH); Tyco Electronics (Shanghai) Co., Ltd., Shanghai (CN)

(72) Inventors: Lei (Alex) Zhou, Shanghai (CN); Dandan (Emily) Zhang, Shanghai (CN); Roberto Francisco-Yi Lu, Bellevue, WA (US); Qing (Carrie) Zhou, Shanghai (CN); Ming (Reuben) Ni, Shanghai (CN); Wenjue Chen, Shanghai (CN); Zhihao Shen, Shanghai (CN); Xianghao (Jorge) Bao, Shanghai (CN); Rong Zhang, Shanghai (CN)

(73) Assignees: TE Connectivity Solutions GmbH, Schaffhausen (CH); Tyco Electronics (Shanghai) Co., Ltd., Shanghai (CN)

(21) Appl. No.: 19/352,602

(22) Filed: Oct. 8, 2025

(30) Foreign Application Priority Data
Oct. 9, 2024 (CN) 202411411277.3

(51) Int. Cl. B66F 17/00; B66F 9/075; B66F 9/14

(52) U.S. Cl. CPC B66F 17/003; B66F 9/0755; B66F 9/14

(57) ABSTRACT

A forklift safety control system includes a sensor mounted on a fork of a forklift and detecting a distance between the fork and an obstacle, a wireless communication device mounted on the fork, and a safety monitoring device. The wireless communication device includes a first wireless communication module connected to the sensor and receiving a distance signal detected by the sensor. The safety monitoring device includes a second wireless communication module in communication with the first wireless communication module and receiving the distance signal from the first wireless communication module, a control module connected to the second wireless communication module, and an alarm connected to the control module. The control module controls the alarm based on the distance signal received by the second wireless communication module. When the distance detected by the sensor is less than a preset safety distance, the control module controls the alarm to alert.

### CROSS-REFERENCE TO RELATED APPLICATIONS

This application claims the benefit of the filing date under 35 U.S.C. § 119(a)-(d) of Chinese Patent Application No. 202411411277.3, filed on Oct. 9, 2024.

### FIELD OF THE INVENTION

The present invention relates to a forklift safety control system and a forklift integrated with the forklift safety control system.

### BACKGROUND OF THE INVENTION

Shelves in warehouses are typically high, and thus it is necessary to load goods into or remove goods from a storage compartment of the shelf by using a forklift capable of vertically lifting. When operating the forklift, an operator cannot see, for example, above the top or in a horizontal direction of the forklift due to blocked sight. Therefore, the operator usually determines a height position and a horizontal position of a fork of the forklift by intuition, which may cause the fork to be likely to collide with a roof of the warehouse or a top beam mounted on the roof or to collide with a floor beam of the shelf, resulting in accidents and affecting the safety of forklift use.

### SUMMARY OF THE INVENTION

A forklift safety control system includes a sensor mounted on a fork of a forklift and detecting a distance between the fork and an obstacle, a wireless communication device mounted on the fork, and a safety monitoring device. The wireless communication device includes a first wireless communication module connected to the sensor and receiving a distance signal detected by the sensor. The safety monitoring device includes a second wireless communication module in communication with the first wireless communication module and receiving the distance signal from the first wireless communication module, a control module connected to the second wireless communication module, and an alarm connected to the control module. The control module controls the alarm based on the distance signal received by the second wireless communication module. When the distance detected by the sensor is less than a preset safety distance, the control module controls the alarm to alert.

### BRIEF DESCRIPTION OF DRAWINGS

In the following, the present invention is described in more detail with references to the drawings in which:

FIG. 1 shows an illustrative view of a forklift according to an exemplary embodiment of the present invention;

FIG. 2 shows an illustrative view of a fork, and a sensor and a wireless communication device mounted on the fork according to an exemplary embodiment of the present invention;

FIG. 3 shows an illustrative view of a fork, and a sensor and a wireless communication device mounted on the fork according to an exemplary embodiment of the present invention, with a cover plate of a first box body opened;

FIG. 4 shows an illustrative perspective view of a safety monitoring device according to an exemplary embodiment of the present invention; and

FIG. 5 shows an illustrative perspective view of a safety monitoring device according to an exemplary embodiment of the present invention, with a cover plate of a second box body opened.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

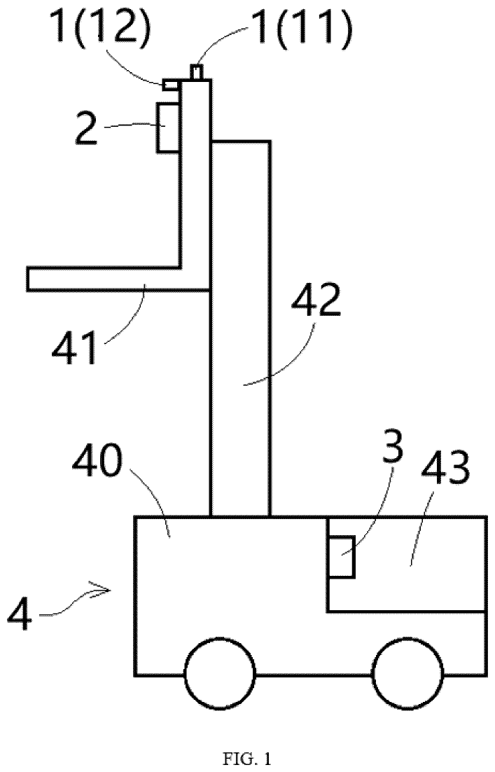

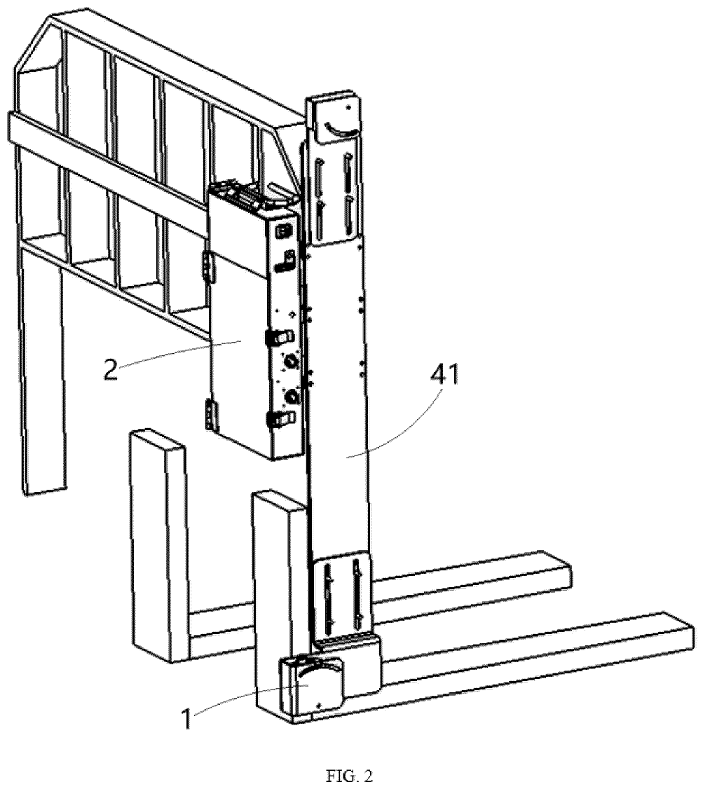

As shown in FIGS. 1 to 5, in an exemplary embodiment of the present invention, a forklift safety control system is disclosed. The forklift safety control system includes: a sensor 1, a wireless communication device 2 and a safety monitoring device 3. The sensor 1 is mounted on a fork 41 of a forklift 4 and configured to detect a distance between the fork 41 and an obstacle. The wireless communication device 2 is mounted on the fork 41 and includes a first wireless communication module 20 connected to the sensor 1. The wireless communication device 2 is configured to receive a distance signal detected by the sensor 1. The safety monitoring device 3 is mounted in a cab 43 of the forklift 4. In this way, a forklift operator seated in the cab 43 can clearly see an alarm 35 of the safety monitoring device 3.

As shown in FIGS. 1 to 5, in the illustrated embodiment, the safety monitoring device 3 includes: a second wireless communication module 30, a control module and the alarm 35. The second wireless communication module 30 is in communication with the first wireless communication module 20 via a wireless network and is configured to receive the distance signal from the first wireless communication module 20. The control module is connected to the second wireless communication module 30 and is configured to control the alarm 35 based on the distance signal received by the second wireless communication module 30. The alarm 35 is connected to the control module. When the distance detected by the sensor 1 is less than a preset safety distance, the control module controls the alarm 35 to alert so as to promptly warn the forklift operator.

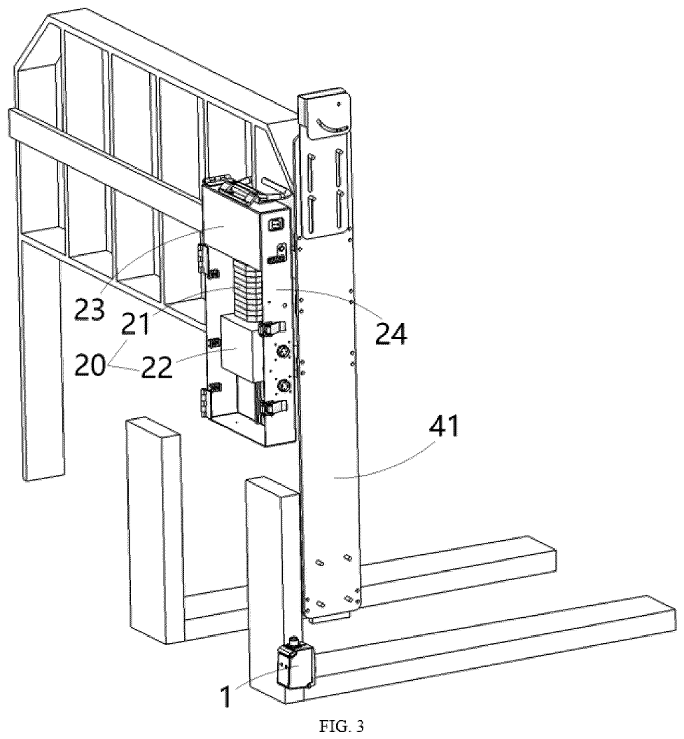

As shown in FIG. 3, in the illustrated embodiment, the wireless communication device 2 further includes a first box body 24. The first wireless communication module 20 is mounted in the first box body 24. The first box body 24 has a cover plate capable of being opened and closed.

As shown in FIG. 3, in the illustrated embodiment, the wireless communication device 2 further includes a first battery 23 mounted in the first box body 24, electrically connected to the first wireless communication module 20 for supplying power to the first wireless communication module 20.

In the illustrated embodiment, the first wireless communication module 20 includes: a first signal processing module 22 and a first wireless communication interface 21. The first signal processing module 22 is configured to process the received distance signal. The first wireless communication interface 21 is adapted to communicate with the second wireless communication module 30 via the wireless network to transmit the distance signal to the second wireless communication module 30.

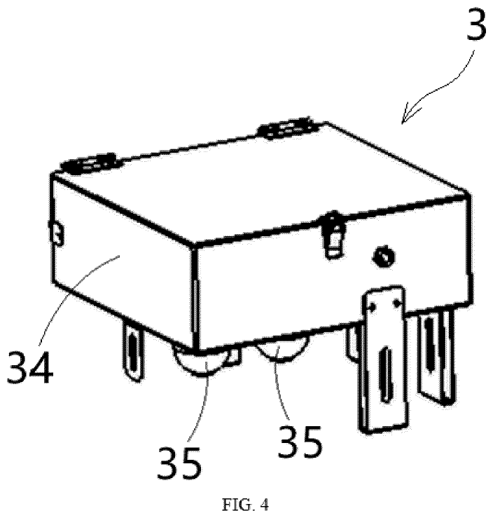

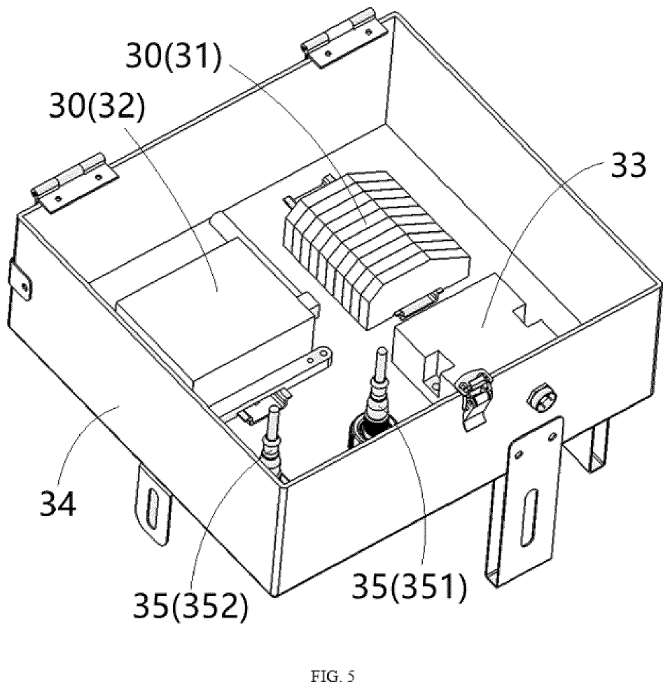

As shown in FIGS. 4 and 5, in the illustrated embodiment, the safety monitoring device 3 further includes a second box body 34. The second wireless communication module 30, the control module and the alarm 35 are mounted in the second box body 34. The second box body 34 has a cover plate capable of being opened and closed.

As shown in FIG. 5, in the illustrated embodiment, the safety monitoring device 3 further includes a second battery 33 mounted in the second box body 34, electrically connected to the second wireless communication module 30 for supplying power to the second wireless communication module 30.

As shown in FIG. 5, in the illustrated embodiment, the second wireless communication module 30 includes: a second wireless communication interface 31 and a second signal processing module 32. The second wireless communication interface 31 is adapted to communicate with the first wireless communication module 20 via the wireless network to receive the distance signal from the second wireless communication module 30. The second signal processing module 32 is configured to process the received distance signal.

In the illustrated embodiment, the alarm 35 includes an alarm light. The control module controls the alarm light to turn red when the distance detected by the sensor 1 is less than the preset safety distance; the control module controls the alarm light to turn green when the distance detected by the sensor 1 is greater than the preset safety distance by a preset value; and the control module controls the alarm light to turn yellow when the distance detected by the sensor 1 is not less than the preset safety distance and a difference therebetween is not greater than the preset value.

In the illustrated embodiment, the alarm 35 includes an alarm bell. The control module controls the alarm bell to sound an alarm ringtone when the distance detected by the sensor 1 is less than the preset safety distance; and the control module controls the alarm bell not to sound an alarm ringtone when the distance detected by the sensor 1 is not less than the preset safety distance.

In an embodiment, the sensor 1 is a non-contact distance sensor 1. In an embodiment, the sensor 1 is a laser distance sensor 1 or an ultrasonic distance sensor 1. As shown in FIG. 1, in the illustrated embodiment, the sensor 1 includes: a first sensor 11 and a second sensor 12. The first sensor 11 is configured to detect a first distance between the fork 41 and the obstacle in a vertical direction. The second sensor 12 is configured to detect a second distance between the fork 41 and the obstacle in a horizontal direction. The control module controls the alarm 35 to alert when the first distance detected by the first sensor 11 is less than a first preset safety distance or the second distance detected by the second sensor 12 is less than a second preset safety distance.

As shown in FIG. 5, in the illustrated embodiment, the alarm 35 includes a first alarm 351 and a second alarm 352. The control module controls the first alarm 351 to alert when the first distance detected by the first sensor 11 is less than the first preset safety distance. The control module controls the second alarm 352 to alert when the second distance detected by the second sensor 12 is less than the second preset safety distance.

As shown in FIG. 1, in the illustrated embodiment, the forklift safety control system includes a plurality of sensors 1, the plurality of sensors 1 being mounted at different parts of the fork 41 and configured to detect distances between the different parts of the fork 41 and the obstacle. The control module controls the alarm 35 to alert when a distance detected by one of the plurality of sensors 1 is less than the preset safety distance.

As shown in FIGS. 1 to 3, in another exemplary embodiment of the present invention, a forklift 4 is also disclosed. The forklift 4 includes: a body 40, a mast 42, a fork 41 and the above forklift safety control system. The body 40 has a cab 43 where a forklift operator sits, the cab 43 may be an enclosed cab or an open cab. The mast 42 is rotatably mounted on the body 40. The fork 41 is movably mounted on the mast 42, capable of moving vertically relative to the mast 42 or rotating inclined about a horizontal axis. The sensor 1 and the wireless communication device 2 are mounted on the fork 41, and the safety monitoring device 3 is mounted in the cab 43.

In an embodiment, the forklift further includes: a first driving device, a second driving device and a third driving device. The first driving device is mounted on the mast 42 and is configured to drive the fork 41 to move in a vertical direction relative to the mast 42. The second driving device is mounted on the body 40 and is configured to drive the mast 42 to rotate around a vertical axis. The third driving device is mounted on the body 40 and is configured to drive the body 40 to move in a horizontal direction.

In an embodiment, the forklift further includes a control device mounted on the body 40 and connected to the second wireless communication module 30 for controlling the first, second and third driving devices. When the distance detected by the sensor 1 is less than the preset safety distance, the control device controls the first, second and third driving devices to stop immediately to prevent the fork 41 from colliding with the obstacle.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “including” an element or a plurality of elements having a particular property may include additional such elements not having that property.

What is claimed is:

1. A forklift safety control system, comprising:
a sensor mounted on a fork of a forklift and detecting a distance between the fork and an obstacle;
a wireless communication device mounted on the fork, the wireless communication device including a first wireless communication module connected to the sensor and receiving a distance signal detected by the sensor; and
a safety monitoring device mounted in a cab of the forklift, the safety monitoring device including:
a second wireless communication module in communication with the first wireless communication module via a wireless network and receiving the distance signal from the first wireless communication module;
a control module connected to the second wireless communication module; and
an alarm connected to the control module, the control module controlling the alarm based on the distance signal received by the second wireless communication module, and when the distance detected by the sensor is less than a preset safety distance, the control module controls the alarm to alert.

2. The forklift safety control system of claim 1, wherein the wireless communication device includes a first box body, the first wireless communication module is mounted in the first box body.

3. The forklift safety control system of claim 2, wherein the wireless communication device includes a first battery mounted in the first box body, the first battery is electrically connected to the first wireless communication module and supplies power to the first wireless communication module.

4. The forklift safety control system of claim 1, wherein the first wireless communication module includes a first signal processing module processing the distance signal and a first wireless communication interface communicating with the second wireless communication module via the wireless network to transmit the distance signal to the second wireless communication module.

5. The forklift safety control system of claim 1, wherein the safety monitoring device includes a second box body, the second wireless communication module, the control module and the alarm are mounted in the second box body.

6. The forklift safety control system of claim 5, wherein the safety monitoring device includes a second battery mounted in the second box body, the second battery is electrically connected to the second wireless communication module and supplies power to the second wireless communication module.

7. The forklift safety control system of claim 1, wherein the second wireless communication module includes a second wireless communication interface communicating with the first wireless communication module via the wireless network to receive the distance signal from the second wireless communication module, and a second signal processing module processing the distance signal.

8. The forklift safety control system of claim 1, wherein the alarm includes an alarm light, the control module controls the alarm light to turn red when the distance detected by the sensor is less than the preset safety distance, the control module controls the alarm light to turn green when the distance detected by the sensor is greater than the preset safety distance by a preset value, and the control module controls the alarm light to turn yellow when the distance detected by the sensor is not less than the preset safety distance and a difference therebetween is not greater than the preset value.

9. The forklift safety control system of claim 1, wherein the alarm includes an alarm bell, the control module controls the alarm bell to sound an alarm ringtone when the distance detected by the sensor is less than the preset safety distance, and the control module controls the alarm bell not to sound the alarm ringtone when the distance detected by the sensor is not less than the preset safety distance.

10. The forklift safety control system of claim 1, wherein the sensor is a non-contact distance sensor.

11. The forklift safety control system of claim 10, wherein the sensor is a laser distance sensor or an ultrasonic distance sensor.

12. The forklift safety control system of claim 1, wherein the sensor includes a first sensor detecting a first distance between the fork and the obstacle in a vertical direction, and a second sensor detecting a second distance between the fork and the obstacle in a horizontal direction, the control module controls the alarm to alert when the first distance detected by the first sensor is less than a first preset safety distance or the second distance detected by the second sensor is less than a second preset safety distance.

13. The forklift safety control system of claim 12, wherein the alarm includes a first alarm and a second alarm, the control module controls the first alarm to alert when the first distance detected by the first sensor is less than the first preset safety distance, and the control module controls the second alarm to alert when the second distance detected by the second sensor is less than the second preset safety distance.

14. The forklift safety control system of claim 1, wherein the sensor is one of a plurality of sensors, the plurality of sensors are mounted at different parts of the fork and detect a plurality of distances between the different parts of the fork and the obstacle, the control module controls the alarm to alert when a distance detected by one of the plurality of sensors is less than the preset safety distance.

15. A forklift, comprising:
a body having a cab;
a mast rotatably mounted on the body;
a fork movably mounted on the mast; and
a forklift safety control system including:
a sensor mounted on the fork and detecting a distance between the fork and an obstacle;
a wireless communication device mounted on the fork, the wireless communication device including a first wireless communication module connected to the sensor and receiving a distance signal detected by the sensor; and
a safety monitoring device mounted in the cab, the safety monitoring device including:
a second wireless communication module in communication with the first wireless communication module via a wireless network and receiving the distance signal from the first wireless communication module;
a control module connected to the second wireless communication module; and
an alarm connected to the control module, the control module controlling the alarm based on the distance signal received by the second wireless communication module, and when the distance detected by the sensor is less than a preset safety distance, the control module controls the alarm to alert.

16. The forklift of claim 15, further comprising a first driving device mounted on the mast and driving the fork to move in a vertical direction relative to the mast.

17. The forklift of claim 16, further comprising a second driving device mounted on the body and driving the mast to rotate around a vertical axis.

18. The forklift of claim 17, further comprising a third driving device mounted on the body and driving the body to move in a horizontal direction.

19. The forklift of claim 18, further comprising a control device mounted on the body and connected to the second wireless communication module, the control device controls the first driving device, the second driving device and the third driving device.

20. The forklift of claim 19, wherein, when the distance detected by the sensor is less than the preset safety distance, the control device controls the first driving device, the second driving device, and the third driving device to stop.
